(19) United States
(12) Patent Application Publication
(10) Pub. No.: US 2003/0233284 A1
(43) Pub. Date: Dec. 18, 2003

(54) System and method for assisting execution of mobile commerce

(76) Inventors: Fu-Yu Liu, Taipei (TW); Yi-Nan Li, Taipei (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/308,556

(22) Filed: Dec. 2, 2002

(30) Foreign Application Priority Data
Jun. 13, 2002 (TW) 091112867

(51) Int. Cl. G06F 17/60

(52) U.S. Cl. 705/26

(57) ABSTRACT

A system for assisting execution of commercial activities by using a mobile terminal (109) includes a client data storing module (305) for storing data on clients, a pending event storing module (306), and an executing data storing module (303). The pending event storing module includes an executing commercial activities interface (401), and a data sheet for storing pending events (404). The executing commercial activities interface connects with the client data storing module and the executing data storing module, accesses data stored in the client data storing module, sends corresponding data to the executing data storing module, and displays data stored in the data sheet for storing pending events. The executing data storing module records data on execution of commercial activities. A related method for assisting execution of commercial activities is also disclosed.

### BACKGROUND OF THE INVENTION

1. Field of the Invention

The present invention relates to a system and method for assisting execution of mobile commerce, and especially to a system and method for assisting execution of mobile commerce by using a mobile terminal.

2. Background of the Invention

Traditional communication means such as letters, telephones, and faxes are used in a typical conventional business model. In such model, many people waste time on data collection and information transfer. Human error leads to serious mistakes being made, which can cause huge damage to an enterprise. There are also other difficulties including providing adequate technical support, high costs, and low customer satisfaction when mistakes occur.

The development of the Internet has given rise to the electronic business model, which relies on Electronic Data Interchange (EDI). Electronic and digitized information is transferred faster and more accurately. The electronic business model breaks through conventional limitations of time and space, enhances the efficiency of running an enterprise, reduces costs, provides more information, and gives the enterprise more business opportunities. The electronic business model allows clients to easily acquire information on merchandise and on an enterprise, and to contact the enterprise instantaneously via the Internet. Further, data collection and integration is much easier.

U.S. patent application with Pub. Ser. No. 2001/0042020 discloses a method for increasing electronic business. An enterprise uses a computer to show its clients data on merchandise. The clients use computers to send purchase requests to the enterprise via the Internet. Finally, the enterprise and the clients reach settled purchase agreements. However, in this method, there is no direct communication between the enterprise and each client. The clients cannot easily obtain more information about the enterprise and its merchandise, and the enterprise cannot easily obtain more information about clients and their requests.

Accordingly, a new business model is desired to make communication between enterprises and clients faster and more accurate, to strengthen technical support, and to yield more client satisfaction.

### SUMMARY OF THE INVENTION

Accordingly, one objective of the present invention is to provide a system for assisting execution of commercial activities by using a mobile terminal.

Another objective of the present invention is to provide a method for assisting execution of commercial activities.

In order to achieve the first above-mentioned objective, the present invention provides a system for assisting execution of commercial activities via a mobile terminal. The system comprises a client data storing module for storing data on clients, a pending event storing module, and an executing data storing module. The pending event storing module comprises an executing commercial activities interface, and a data sheet for storing pending events. The executing commercial activities interface connects with the client data storing module and the executing data storing module, accesses data stored in the client data storing module, sends corresponding data to the executing data storing module, and displays data stored in the data sheet for storing pending events. The executing data storing module records data on execution of commercial activities.

In order to achieve the second above-mentioned objective, a method for assisting execution of mobile commerce in accordance with the present invention comprises the steps of: (a) scanning a bar code of a client; (b) displaying data on the client represented by the bar code; (c) displaying one or more pending events; (d) displaying steps for executing all pending events; and (e) storing data on commercial activities in an executing data storing module.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of a system for execution of mobile commerce in accordance with a preferred embodiment of the present invention, the system comprising a database server, a mobile commerce server and at least one mobile terminal;

FIG. 2 is a schematic diagram of detailed infrastructure of the database server of the system of FIG. 1, and shows data communication between the database server, the mobile commerce server and one mobile terminal;

FIG. 3 is a schematic block diagram of function modules of one mobile terminal of the system of FIG. 1;

FIG. 4 is a schematic block diagram showing details of and data communication between certain of the function modules of the mobile terminal schematically illustrated in FIG. 3;

FIG. 5 is a flowchart of execution of mobile commerce in accordance with a preferred embodiment of the present invention; and

FIG. 6 is a flowchart of details of one step of FIG. 5, namely assisting execution of commercial activities.

### DETAILED DESCRIPTION OF PREFERRED EMBODIMENTS OF THE INVENTION

Reference will now be made to the drawings to describe the present invention in detail.

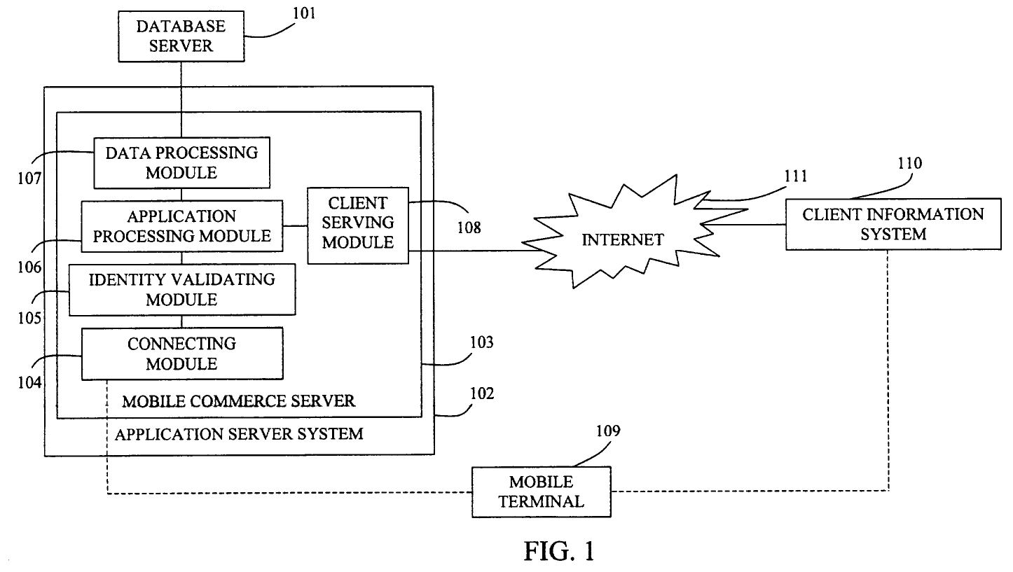

FIG. 1 is a schematic diagram of a system for assisting execution of mobile commerce in accordance with a preferred embodiment of the present invention. The system for assisting execution of mobile commerce comprises a three-tier information system. The three-tier information system comprises a database server 101 (the bottom tier), an application server system 102 (the middle tier), and a plurality of distributed terminal workstations 109 (the top tier, only one shown). The application server system 102 of the preferred embodiment comprises a mobile commerce server 103. Each terminal workstation 109 of the preferred embodiment is a mobile terminal 109, which can be a Personal Digital Assistant (PDA), a pocket personal computer (PC), a laptop computer, a palmtop computer, a smart phone or a notebook computer. A client information system 110 connects with each of the mobile terminals 109 via a cable, infrared signals, or wireless communications. Each mobile terminal 109 connects with the mobile commerce server 103 via a cable, infrared signals, or wireless communications. The mobile commerce server 103 connects with the database server 101, and is used for creating business schedules in accordance with data stored in the database server 101. The mobile terminal 109 downloads a business schedule from the mobile commerce server 103, for assisting execution of commercial activities. The mobile terminal 109 shows steps of required commercial activities in accordance with the business schedule, records data on execution of commercial activities, and uploads data on transactions and on execution of commercial activities for updating of data stored in the client information system 110.

The mobile commerce server 103 comprises a connecting module 104, an identity validating module 105, an application processing module 106, a data processing module 107, and a client serving module 108. The connecting module 104 connects with the mobile terminal 109, and is used for transferring data between the mobile terminal 109 and the mobile commerce server 103. The identity validating module 105 checks identities of personnel such as sales representatives, and distributes various business schedules to various sales representatives. The application processing module 106 creates business schedules for every sales representative in accordance with data stored in the database server 101, and updates data stored in the database server 101 in accordance with data sent from the mobile terminal 109. The data processing module 107 connects with the database server 101, and transfers data between the database server 101 and the mobile commerce server 103. The client serving module 108 connects with the client information system 110 via the Internet 111. The client serving module 108 sends information on mobile commerce to clients, and receives data on cooperating with clients and data on requirements of clients.

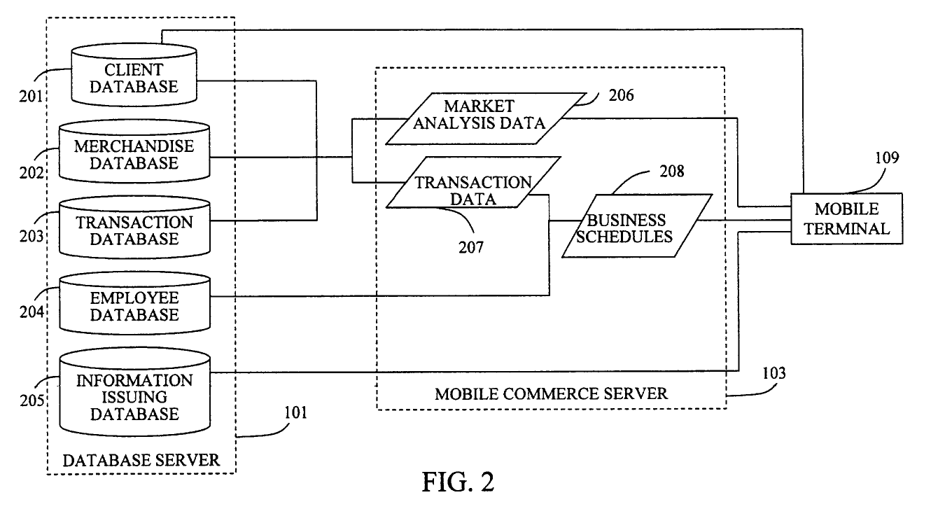

FIG. 2 is a schematic diagram of detailed infrastructure of the database server 101, and shows data communication between the database server 101, the mobile commerce server 103 and one mobile terminal 109. The database server 101 is a central database of an entire enterprise. The database server 101 comprises: a client database 201 for storing data on clients; a merchandise database 202 for storing data on merchandise sold by the enterprise; a transaction database 203 for storing transaction data on the enterprise; an employee database 204 for storing employee data including data on all sales representatives; and an information issuing database 205 for storing information issued by the enterprise. The application processing module 106 of the mobile commerce server 103 integrates data stored in the client database 201, data stored in the merchandise database 202, and data stored in the transaction database 203 to create transaction data 207 and market analysis data 206. The transaction data 207 and the market analysis data 206 are stored in the mobile commerce server 103. The transaction data 207 and data stored in the employee database 204 are processed by the application processing module 106 to create business schedules 208 for sales representatives. The business schedules 208 are stored in the mobile commerce server 103. During the process of downloading data from the mobile commerce server 103, the business schedules 208, the market analysis data 206, data stored in the client database 201, and data stored in the information issuing database 205 are transferred to the mobile terminal 109 via the connecting module 104 of the mobile commerce server 103.

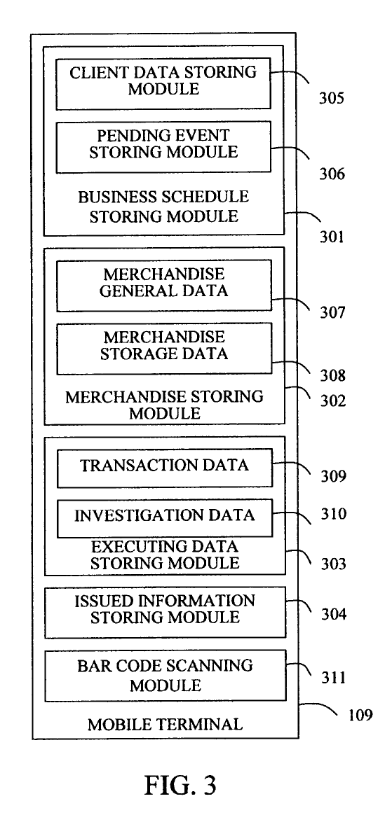

FIG. 3 is a schematic block diagram of function modules of one mobile terminal 109. The mobile terminal 109 comprises: a business schedule storing module 301 which is used to record work flow and clients that a sales representative visits; a merchandise storing module 302 which is used to store all merchandise information on the enterprise as a reference for the sales representative to inquire of; an executing data storing module 303 which is used to record data on execution of commercial activities; an issued information storing module 304 which is used to store information on the enterprise's current news, merchandise shortage notes, and newly promoted products; and a bar code scanning module 311 which is used to scan and identify various clients' bar codes which respectively represent various clients.

The business schedule storing module 301 comprises a client data storing module 305, and a pending event storing module 306. The client data storing module 305 stores commercial activities information on clients, including client basic data such as name, address and phone number, client ordering data, and accounts receivable. The pending event storing module 306 is used to remind the sales representative of matters that need to be attended to. For instance, such matters may be orders that need conducting, collection of accounts receivable, and market investigation. The merchandise storing module 302 comprises merchandise general data 307 and merchandise storage data 308. The merchandise general data 307 includes basic merchandise data such as name, serial number and specification, merchandise price data and key merchandise data. The merchandise storage data 308 includes corresponding merchandise inventory volume and distribution information. The executing data storing module 303 stores transaction data 309 and investigation data 310. The information in the executing data storing module 303 is sent to the mobile commerce server 103, and is processed by the application processing module 106. The information in the database server 101 is updated accordingly.

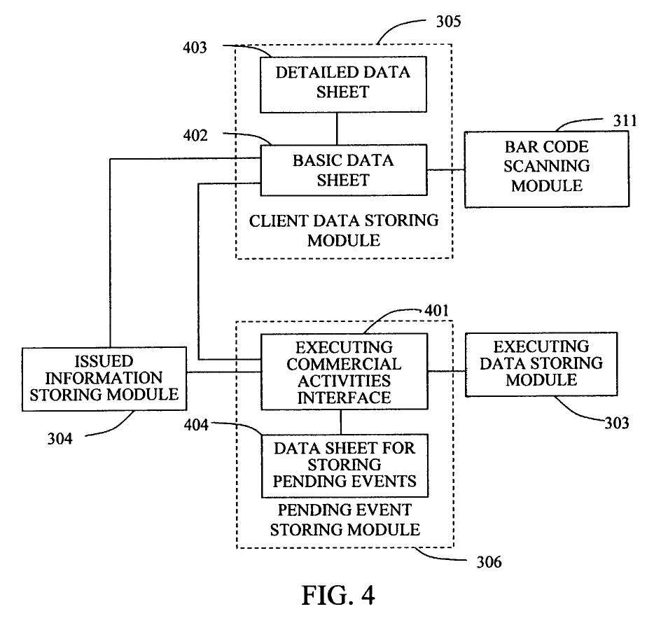

FIG. 4 is a schematic block diagram showing details of and data communication between certain of the function modules of the mobile terminal 109 schematically illustrated in FIG. 3. The pending event storing module 306 comprises an executing commercial activities interface 401, and a data sheet for storing pending events 404 electronically linked with the executing commercial activities interface 401. The client data storing module 305 comprises a basic data sheet 402 and a detailed data sheet 403.

The executing commercial activities interface 401 is a unique interface of the system for assisting execution of mobile commerce. The executing commercial activities interface 401 provides functions of next, note, and cancel for executing data displayed in the interface; and further provides the function of storing data input by a user to the executing data storing module 303. The executing commercial activities interface 401 connects with the executing data storing module 303, the issued information storing module 304, and the basic data sheet 402. The data sheet for storing pending events 404 stores steps for executing pending events. The order of the steps corresponds with a work flow of a business transaction. The basic data sheet 402 stores client basic information such as client name, client code, and type of store run by the client. Each client code corresponds with a bar code of that client. The type of store may be a supermarket or a chain store. The bar code scanning module 311 links with the basic data sheet 402, and sends a client bar code to the basic data sheet 402 to enable information on the corresponding client to be obtained. The issued information storing module 304 links with the basic data sheet 402 according to the type of store of a client. The detailed data sheet 403 links with the basic data sheet 402 according to the client code of a client.

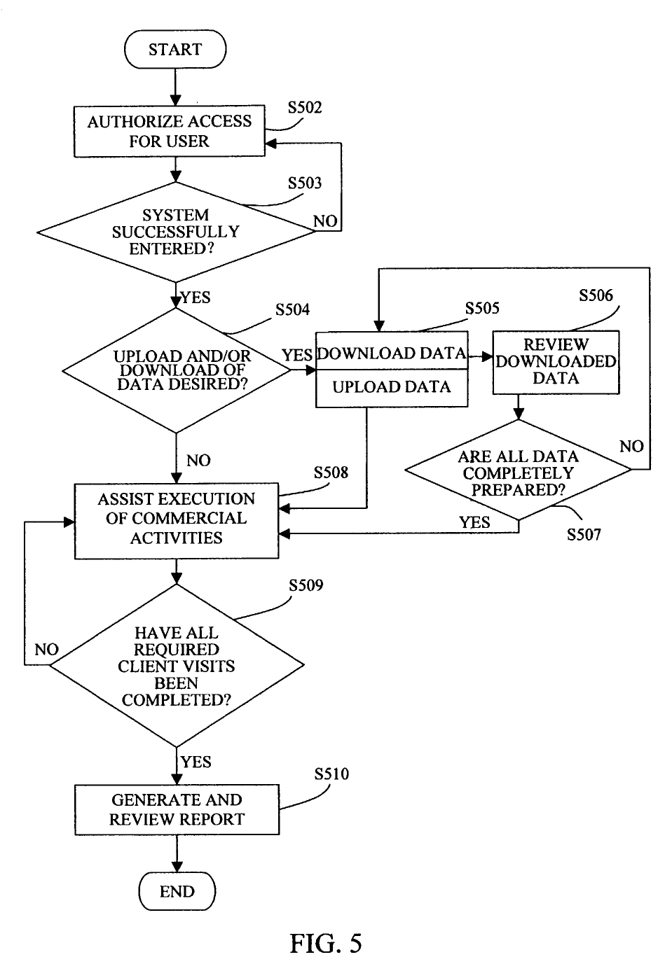

FIG. 5 is a flowchart of execution of mobile commerce in accordance with a preferred embodiment of the present invention. Firstly, in step S502, before a user enters the system, the mobile terminal 109 authorizes access for the user. In step S503, if the user cannot successfully enter the system, then the procedure returns to step S502. If the user successfully enters the system, then in step S504, the mobile terminal 109 inquires whether or not the user wants to upload and/or download data. If the user does not want to upload or download data, then the procedure proceeds directly to step S508 described below. Otherwise, in step S505, the mobile terminal 109 downloads data including a business schedule from the mobile commerce server 103, and/or uploads data on execution of commercial activities already completed to the executing data storing module 303 of the mobile commerce server 103. These download and upload operations can be performed individually and separately. If the mobile terminal 109 only uploads data, then the procedure proceeds directly to step S508. If the mobile terminal 109 downloads data, then in step S506, when all the data have been downloaded, the mobile terminal 109 displays the downloaded data and a summary prepared by the user of items needed by the user for execution of commercial activities. The user compares the downloaded data with the needed items, and marks any outstanding needed items. Then, in step S507, the business schedule storing module 301 determines whether all the downloaded data are prepared having regard to the user's mark, if any. If the downloaded data are not prepared, then the procedure returns to step S505, and the outstanding wanted data are downloaded. If the downloaded data are prepared, then the procedure proceeds directly to step S508. In step S508, the actual commercial activities are performed, and the executing data storing module 303 records corresponding operations during the process of execution of the commercial activities. When the commercial activities are finished, in step S509 the business schedule storing module 301 determines whether all required visits to clients have been completed. If all required client visits have not been completed, then the procedure returns to step S508 and the sales representative continues to visit other clients. If and when all required client visits have been completed, then in step S510, the executing data storing module 303 collects and analyzes all client visit information on the business schedule, and generates a consolidated report for the sales representative to review.

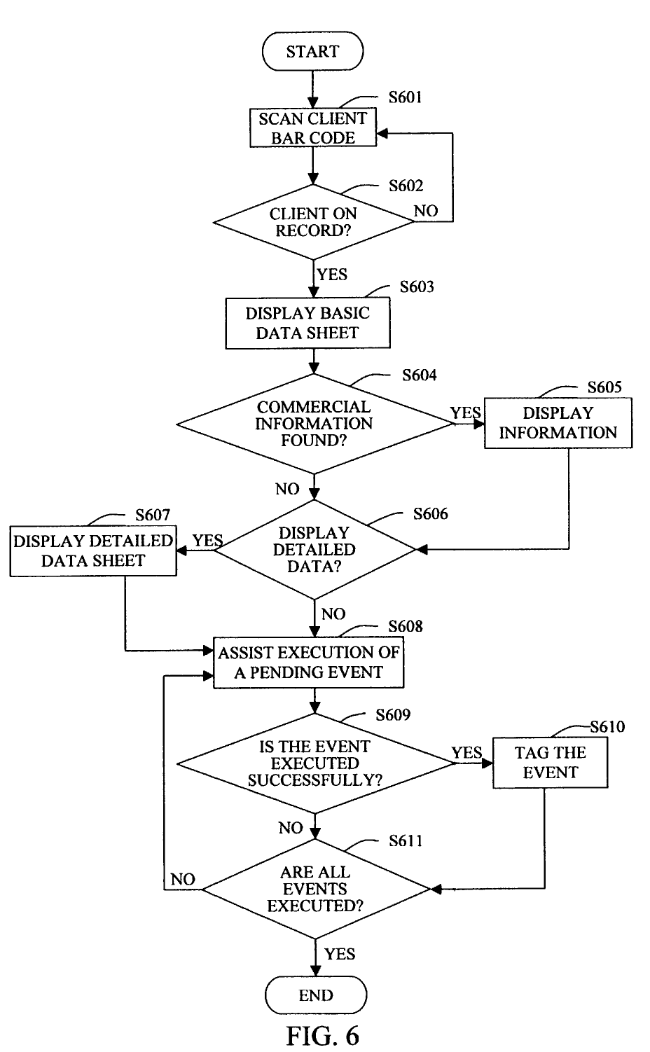

FIG. 6 is a flowchart of details of step S508 of FIG. 5, namely assisting execution of commercial activities. Firstly, in step S601, the mobile terminal 109 scans a bar code of a client. In step S602, the bar code scanning module 311 searches for a corresponding code of the client in the basic data sheet 402 to determine whether the client is on record. If the client is on record, then in step S603, the executing commercial activities interface 401 displays the client's basic data. If the client is not on record, the procedure returns to step S601.

In step S604, the executing commercial activities interface 401 reads the type of store of the client from the basic data sheet 402, and searches in the issued information storing module 304 to find information on commercial activities relating to that type of store. If no relevant information is found, the procedure proceeds directly to step S606 described below. Otherwise, in step S605 the executing commercial activities interface 401 displays the information found. In step S606, the executing commercial activities interface 401 prompts the sales representative to select whether to display the client's detailed data. If the sales representative does not want the detailed data displayed, then the procedure proceeds directly to step S608 described below. If the sales representative wants the detailed data displayed, then in step S607, the executing commercial activities interface 401 displays the detailed data sheet 403.

In step S608, the executing commercial activities interface 401 displays steps of execution of pending events, to guide the sales representative in execution of commercial activities. During execution of the commercial activities, the executing commercial activities interface 401 records data on execution of pending events and data input by the sales representative, and stores such data in the executing data storing module 303. The sales representative inputs to the executing commercial activities interface 401 data on success or otherwise of each step of the pending event, after execution of each such step. In step S609, the executing commercial activities interface 401 determines whether a pending event has been successfully executed in accordance with data input by the sales representative. The pending event is regarded as successfully executed if every step of the pending event has been successfully executed. If the pending event has been successfully executed, then in step S610, the executing commercial activities interface 401 tags the event as completed, whereupon the procedure proceeds to step S611 described below. If the pending event has not been successfully executed, then the procedure proceeds directly to step S611. In step S611, the executing commercial activities interface 401 determines whether all pending events corresponding to the client have been executed. If all pending events corresponding to the client have been executed, then the executing commercial activities interface 401 ends the procedure. If all pending events corresponding to the client have not been executed, then the procedure returns to step S608.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for assisting execution of mobile commerce via a mobile terminal, the system comprising:
a client data storing module for storing data on clients;
an executing data storing module; and
a pending event storing module; wherein
the pending event storing module comprises an executing commercial activities interface and a data sheet for storing pending events;
the executing commercial activities interface connects with the client data storing module, the data sheet for storing pending events and the executing data storing module, accesses data stored in the client data storing module, sends corresponding data to the executing data storing module, and displays the data sheet for storing pending events; and
the executing data storing module records data on execution of commercial activities.

2. The system for assisting execution of mobile commerce as claimed in claim 1, wherein the client data storing module comprises a basic data sheet and a detailed data sheet.

3. The system for assisting execution of mobile commerce as claimed in claim 1, further comprising a bar code scanning module for reading bar codes of clients.

4. The system for assisting execution of mobile commerce as claimed in claim 1, further comprising an issued information storing module which connects with the basic data sheet for storing data on issued information on an enterprise.

5. The system for assisting execution of mobile commerce as claimed in claim 4, wherein the executing commercial activities interface accesses data stored in the issued information storing module.

6. A method for assisting execution of mobile commerce, the method comprising the steps of:
(a) scanning a bar code of a client;
(b) displaying data on the client represented by the bar code;
(c) displaying one or more pending events related to the client;
(d) displaying steps for executing all pending events; and
(e) storing data on commercial activities in an executing data storing module.

7. The method for assisting execution of mobile commerce as claimed in claim 6, wherein the step of scanning a bar code of a client can be substituted by the step of inputting the client's name and/or a code of the client.

8. The method for assisting execution of mobile commerce as claimed in claim 6, further comprising the step of:
receiving data input by a sales representative during execution of commercial activities, and storing the data to the executing data storing module.

9. A method of assisting a sales representative to execute mobile commerce in visiting a customer, comprising steps of:
providing the sales representative with connection to a center database via a mobile server when said sales representative is visiting or ready to visit a customer regardless of whether said customer is new or old;
providing said sales representative with necessary information regarding said customer via said connection;
providing said sales representative with required pending events related to said customer via said connection; and
providing the center database with data on actual commercial activities of the sales representative relating to said required pending events via said connection.
